(19) United States
(12) Patent Application Publication
(10) Pub. No.: US 2020/0307673 A1
(43) Pub. Date: Oct. 1, 2020

(54) STEERING SHAFT

(71) Applicant: YAMADA MANUFACTURING CO., LTD., Kiryu-shi (JP)

(72) Inventor: Tomoya Ishikawa, Kiryu-shi (JP)

(21) Appl. No.: 16/747,101

(22) Filed: Jan. 20, 2020

(30) Foreign Application Priority Data
Mar. 26, 2019 (JP) 2019-058414

(51) Int. Cl. B62D 1/20; F16J 15/3232

(52) U.S. Cl. CPC B62D 1/20; F16J 15/3232

(57) ABSTRACT

A steering shaft according to an aspect of the present invention includes a shaft main body, an upper shaft, a lower shaft, and a seal mechanism. The seal mechanism includes a first lip portion configured to surround a periphery of the lower shaft and slide on an outer peripheral surface of the lower shaft, and a flange portion configured to surround a periphery of the first lip portion and protrude downward from the first lip portion.

### INCORPORATED DESCRIPTION OF RELEVANT APPLICATION

Priority is claimed on Japanese Patent Application No. 2019-058414, filed on Mar. 26, 2019, the content of which is incorporated herein by reference.

### BACKGROUND OF INVENTION

### Field of Invention

The present invention relates to a steering shaft.

### Background Art

A steering shaft having an intermediate shaft (hereinafter, simply referred to as an intermediate shaft) is known. The intermediate shaft connects between a shaft main body to which a steering wheel is coupled and a steering gear box coupled to a wheel. The intermediate shaft is configured such that a lower shaft and an upper shaft are movable relative to each other and rotatable integrally with each other in an axial direction.

For example, the above-described intermediate shaft may be disposed at a position exposed to an external environment in an engine room. For this reason, there is a possibility that water, muddy water, or the like may adhere to the intermediate shaft at the time of running-up or when submerged. If water or the like enters a fitting portion between the lower shaft and the upper shaft, the intermediate shaft may corrode.

Accordingly, for example, Japanese Unexamined Patent Application, First Publication No. 2009-19710 discloses a configuration in which a seal that is in sliding contact with an outer peripheral surface of a lower shaft is provided at a lower end portion of an upper shaft.

However, in the above-described related art, there is still room for improvement in terms of preventing water from entering the fitting portion of the intermediate shaft.

An aspect according to the present invention provides a steering shaft capable of suppressing entry of water or the like.

### SUMMARY OF INVENTION

In order to solve the above-described problems, the present invention adopts the following aspects.

(1) According to an aspect of the present invention, there is provided a steering shaft including: a shaft main body configured to have a rear end portion to which a steering wheel is coupled; an upper shaft configured to be connected to a front end portion of the shaft main body; a lower shaft configured to be coaxially provided with the upper shaft on a lower end portion of the upper shaft, to be movable in an axial direction relative to the upper shaft, and to be rotatable integrally with the upper shaft; and a seal mechanism configured to be provided in the upper shaft and seal between the lower shaft and the upper shaft. The seal mechanism includes a lip portion configured to surround a periphery of the lower shaft and slide on an outer peripheral surface of the lower shaft, and a flange portion configured to surround a periphery of the lip portion and protrude downward from the lip portion.

In the aspect, the lip portion is covered by the flange portion, and thus, the water or the like reaching the lip portion can be reduced. Thereby, entry of water or the like into a fitting portion of the lower shaft and the upper shaft can be suppressed.

The water or the like reaching the lip portion is reduced, and thus, a water pressure acting on the lip portion can be reduced. Therefore, a seal load (a load acting on the outer peripheral surface of the lower shaft from the first lip portion) is reduced, and thus, sealing performance can be secured. The seal load is reduced, and thus, a sliding resistance between the lip portion and the lower shaft is reduced, and durability can be improved.

(2) In the steering shaft according to (1), the lip portion may include a first lip portion configured to extend downward as the first lip portion goes toward an outer peripheral surface of the lower shaft, and a second lip portion configured to surround the periphery of the lower shaft above the first lip portion and slide on the outer peripheral surface of the lower shaft. A first lubricant storage portion in which lubricant is stored may be defined between the first lip portion and the second lip portion.

In the aspect, the water or the like which has reached the first lip portion from below can be more reliably blocked at the first lip portion. The first lip portion is easily bent and deformed in a direction close to or away from the lower shaft, and thus, the seal load can be reduced.

In the aspect, the plurality of first lip portion and second lip portion are arranged in the up-down direction, and thus, the sealing performance can be further improved.

A portion between the first lip portion and the second lip portion is the first lubricant storage portion, and thus, lubricant is easily supplied between each lip portion and the lower shaft. Therefore, a sliding resistance between each lip portion and the lower shaft can be reduced. Lubricant is supplied between each lip portion and the lower shaft, and thus, a gap between each lip portion and the lower shaft can be filled with lubricant. Thereby, the sealing performance can be further improved.

(3) In the steering shaft according to (1) or (2), the seal mechanism may include a double seal configured to slide on the outer peripheral surface of the lower shaft, in a portion located above the first lip portion. A second lubricant storage portion in which lubricant is stored may be inside the double seal.

In the aspect, lubricant can be stored inside the double seal. Thereby, lubricant is easily supplied between the double seal and the lower shaft. Accordingly, a sliding resistance between the double seal and the lower shaft can be reduced.

(4) In the steering shaft according to (3), the double seal may include a lower lip portion and an upper lip portion configured to slide on the outer peripheral surface of the lower shaft. A shape of each of the lower lip portion and the upper lip portion in a cross-sectional view may be formed in a semicircular shape which is convex toward the lower shaft.

In the aspect, each lip portion of the double seal is formed in a semicircular shape. Therefore, each lip portion is prevented from being caught on the outer peripheral surface of the lower shaft with respect to a movement of the lower shaft toward both the upper and lower sides, and thus, the lower shaft can be smoothly moved.

(5) In the steering shaft according to any one of (1) to (4), the flange portion may extend along an axial direction of the upper shaft and the lower shaft.

For example, according to the aspect, compared to a configuration in which a diameter of the flange portion increases toward the lower side, the water or the like can be prevented from reaching the lip portion (the fitting portion between the lower shaft and the upper shaft) through a portion between the outer surface of the lower shaft and the flange portion. Meanwhile, for example, compared to a configuration in which the diameter of the flange portion decreases toward the lower side, the water or the like moving downward on the outer peripheral surface of the flange portion can be prevented from adhering to the outer peripheral surface of the lower shaft.

### Effect of Invention

According to each aspect, the entry of the water or like can be suppressed.

### BRIEF DESCRIPTION OF DRAWINGS

FIG. 1 is a perspective view of a steering device according to a first embodiment.

FIG. 2 is a cross-sectional view taken along line II-II of FIG. 1.

FIG. 3 is an enlarged cross-sectional view of an intermediate shaft according to the first embodiment.

FIG. 4 is a cross-sectional view corresponding to FIG. 3 according to a modification example.

FIG. 5 is a cross-sectional view corresponding to FIG. 3 according to the modification example.

FIG. 6 is a cross-sectional view of an intermediate shaft according to a second embodiment.

FIG. 7 is a cross-sectional view of an intermediate shaft according to another configuration of the second embodiment.

### DETAILED DESCRIPTION OF INVENTION

Next, embodiments of the present invention will be described with reference to the drawings.

### First Embodiment

[Steering Device]

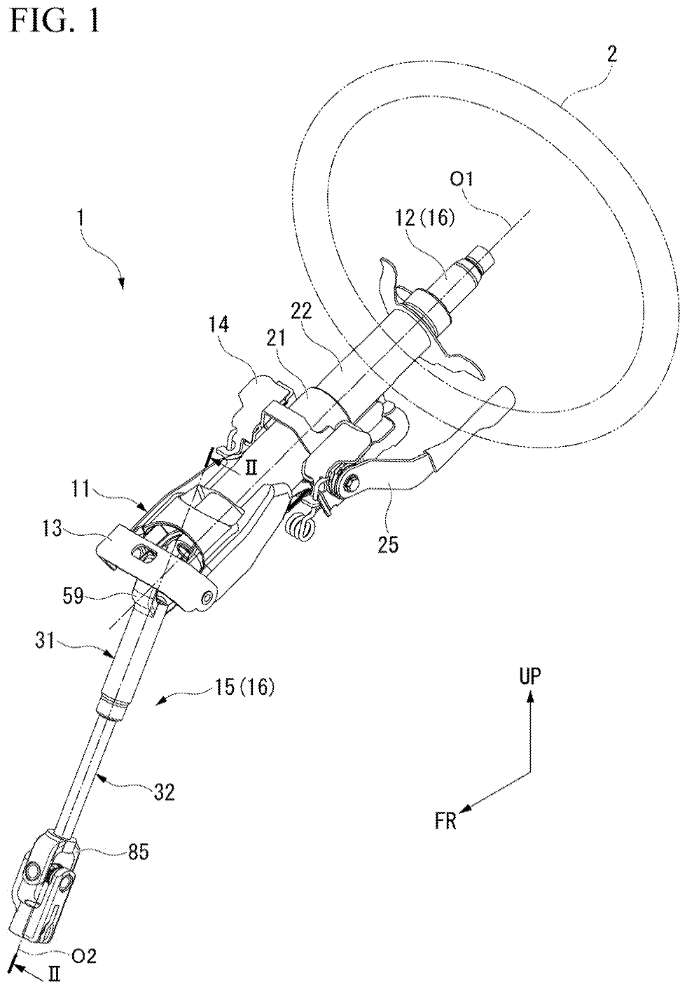

FIG. 1 is a perspective view of a steering device 1.

As shown in FIG. 1, the steering device 1 is mounted on a vehicle. The steering device 1 adjusts a steering angle of a wheel according to a rotation of a steering wheel 2.

The steering device 1 includes a column unit 11, a shaft main body 12, fixing brackets (front bracket 13 and rear bracket 14), and an intermediate shaft (slide shaft) 15. Each of the column unit 11 and the shaft main body 12 is formed along a first axis O1. Therefore, in the following descriptions, a direction in which the first axis O1 of the column unit 11 and the shaft main body 12 extends may be simply referred to as a first axis direction, a direction orthogonal to the first axis O1 may be referred to as a first radial direction, and a direction around the first axis O1 may be referred to as a first circumferential direction. The shaft main body 12 and the intermediate shaft 15 constitute a steering shaft 16 according to this embodiment.

The steering device 1 of the present embodiment is mounted on a vehicle in a state where the first axis O1 intersects a front-rear direction. The first axis O1 of the steering device 1 extends upward as the first axis O1 goes rearward. However, in the following descriptions, for the sake of convenience, in the steering device 1, a direction toward the steering wheel 2 in the first axis direction is simply referred to as a rear, and a direction toward a side opposite to the steering wheel 2 is simply referred to as a front (arrow FR). Further, in the first radial direction, an up-down direction in a state where the steering device 1 attached to the vehicle is simply an up-down direction (arrow UP is upward), and a right-left direction is simply a right-left direction.

The column unit 11 includes an outer column 21 and an inner column 22.

The outer column 21 is attached to a vehicle body via the fixing brackets 13 and 14.

The inner column 22 is formed in a tubular shape extending along the first axis O1. An outer diameter of the inner column 22 is smaller than an inner diameter of the outer column 21. The inner column 22 is inserted into the outer column 21. The inner column 22 is configured to be movable in the first axis direction with respect to the outer column 21.

The shaft main body 12 is formed in a hollow cylindrical shape extending along the first axis O1. The shaft main body 12 is supported in the inner column 22 so as to be rotatable around the first axis O1 via a bearing (not shown). The steering wheel 2 is coupled to a rear end portion of the shaft main body 12.

The fixing brackets 13 and 14 connect between the outer column 21 and the vehicle body.

The front bracket 13 is formed in a U shape which opens downward in a front view when viewed in the first axis direction. The front bracket 13 supports the outer column 21 in a state where the front bracket 13 surrounds a front end portion of the outer column 21 from above and both sides in the right-left direction.

The rear bracket 14 is formed in a U shape which opens downward in the front view when viewed in the first axis direction. The rear bracket 14 supports the outer column 21 in a state where the rear bracket 14 surrounds a rear portion of the outer column 21 from above and both sides in the right-left direction.

An adjustment mechanism 25 is provided in the rear bracket 14. The adjustment mechanism 25 switches the inner column 22 between a locked state and an unlocked state. The locked state is a state in which a movement of the inner column 22 with respect to the outer column 21 in the up-down direction and the front-rear direction is restricted. The unlocked state is a state in which the movement of the inner column 22 with respect to the outer column 21 in the up-down direction and the front-rear direction is allowed.

<Intermediate Shaft>

The intermediate shaft 15 connects between the shaft main body 12 and a steering gear box (not shown) in an outside (for example, an engine room or the like) of a vehicle compartment. The intermediate shaft 15 extends downward from a front end portion of the shaft main body 12 toward the front.

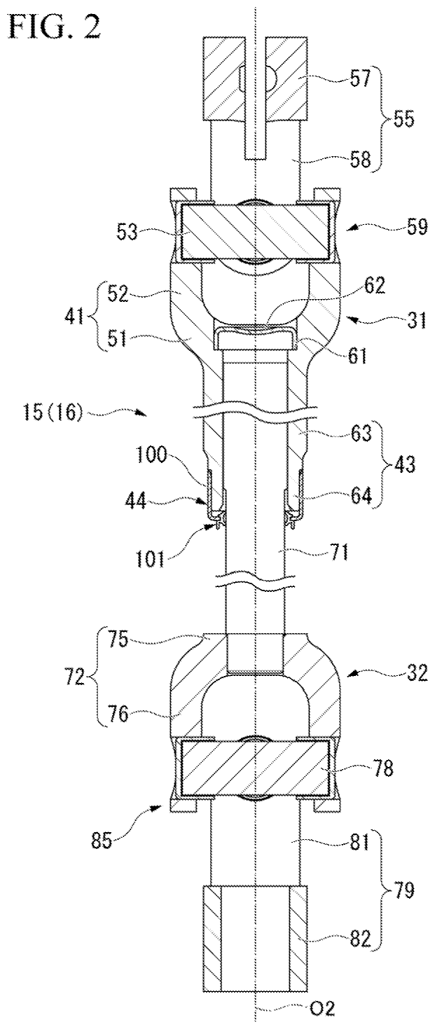

FIG. 2 is a cross-sectional view taken along line II-II of FIG. 1.

As shown in FIG. 2, the intermediate shaft 15 includes an upper shaft 31 and a lower shaft 32. The upper shaft 31 and the lower shaft 32 are coaxially disposed on a second axis O2 which intersects the above-described first axis O1. Therefore, in the following descriptions, a direction in which the second axis O2 extends may be simply referred to as a second axis direction, a direction orthogonal to the second axis O2 may be referred to as a second radial direction, and a direction around the second axis O2 may be referred to as a second circumferential direction. In the following descriptions, a direction toward the steering wheel 2 in the second axis direction is simply an upper side and a direction toward a side opposite to the steering wheel 2 is simply a lower side.

The upper shaft 31 is connected to the front end portion of the shaft main body 12. The upper shaft 31 includes a first upper yoke 41, a tubular portion 43, and a seal mechanism 44.

The first upper yoke 41 includes a first upper base 51 and a first upper arm 52. The first upper base 51 has an annular shape which is disposed coaxially with the second axis O2. The first upper arm 52 extends to be bifurcated upward from the first upper base 51. A second upper yoke 55 is connected to the first upper arm 52 via an upper X-shaped shaft 53. Each first upper arm 52 rotatably supports two rotary shafts of four rotary shafts of the upper X-shaped shaft 53.

The second upper yoke 55 includes a second upper base 57 and a second upper arm 58.

The second upper base 57 is coupled to the front end portion of the above-described shaft main body 12.

The second upper arm 58 extends to be bifurcated downward from the second upper base 57. The second upper arm 58 rotatably supports the other two rotary shafts among the four rotary shafts of the above-described upper X-shaped shaft 53. The first upper yoke 41, the upper X-shaped shaft 53, and the second upper yoke 55 constitute an upper universal joint 59.

The tubular portion 43 extends downward from the first upper base 51. A female spline is formed on an inner peripheral surface of the tubular portion 43. An inner diameter of the tubular portion 43 is smaller than an inner diameter of the first upper base 51. A seal cap 62 is fitted into a fitting recess 61 which is formed between an inner peripheral surface of the first upper base 51 and an upper end surface of the tubular portion 43. The seal cap 62 is formed in a bottomed tubular shape. A peripheral wall portion of the seal cap 62 is fitted to an inner peripheral surface (inner peripheral surface of first upper base 51) of the fitting recess 61, and thus, an upper end opening portion of the tubular portion 43 is closed. In the present embodiment, the case where a stepped portion formed between the inner peripheral surface of the first upper base 51 and the upper end surface of the tubular portion 43 is the fitting recess 61 is described. However, the present invention is not limited to this configuration. In the fitting recess 61, in a case where the inner peripheral surface of the first upper base 51 and the inner peripheral surface of the tubular portion 43 are formed to be flush with each other, a separate fitting recess 61 may be formed in the inner peripheral surface of the first upper base 51, the inner peripheral surface of the tubular portion 43, or the like.

An outer diameter of the tubular portion 43 is gradually reduced downward. The tubular portion 43 includes a large-diameter portion 63 which is located on an upper portion thereof and a small-diameter portion 64 which is located below the large-diameter portion 63. The above-described seal mechanism 44 is attached to the small-diameter portion 64. The seal mechanism 44 will be described in detail later.

The lower shaft 32 is connected to a lower end portion of the upper shaft 31. The lower shaft 32 includes a shaft 71 and a first lower yoke 72.

The shaft 71 is a solid shaft which is disposed coaxially with the second axis O2. A male spline is formed on an outer peripheral surface of an upper portion of the shaft 71. The shaft 71 is inserted into the tubular portion 43 from below in a state where the shaft 71 engages (meshes) with the female spline of the upper shaft 31. The shaft 71 is configured to be slidable in the up-down direction (second axis direction) with respect to the upper shaft 31 in a state where a rotation of the shaft 71 in the second circumferential direction is restricted. The lower shaft 32 moves in the up-down direction with respect to the upper shaft 31, which absorbs a displacement in the second axis direction which is generated when the vehicle travels and suppresses a displacement and vibration transmitted to the steering wheel 2. An outer peripheral surface of a portion of the shaft 71 protruding forward from the upper shaft 31 is formed in a smooth surface.

The first lower yoke 72 protrudes downward from a lower end portion of the shaft 71. The first lower yoke 72 includes a first lower base 75 and a first lower arm 76. The first lower base 75 has an annular shape which is disposed coaxially with the second axis O2. The lower end portion of the shaft 71 is fitted into the first lower base 75. The first lower base 75 is connected to the shaft 71 by press fitting or the like.

The first lower arm 76 extends to be bifurcated downward from the first lower base 75. A second lower yoke 79 is connected to the first lower arm 76 via a lower X-shaped shaft 78. Each first lower arm 76 rotatably supports two rotary shafts of four rotary shafts of the lower X-shaped shaft 78.

The second lower yoke 79 includes a second lower arm 81 and a second lower base 82.

The second lower arm 81 rotatably supports the other two rotary shafts among the four rotary shafts of the above-described lower X-shaped shaft 78.

The second lower base 82 connects lower end portions of the second lower arm 81 to each other. The second lower base 82 is coupled to the steering gear box. In addition, the steering gear box includes a pinion shaft, a rack shaft, or the like. The pinion shaft is connected to the second lower base 82 and rotates as the intermediate shaft 15 rotates. The rack shaft extends in a vehicle width direction. Both end portions of the rack shaft in the vehicle width direction are connected to the wheel via tie rods or the like. The rack shaft is configured to be movable in the vehicle width direction as the pinion shaft rotates. That is, the intermediate shaft 15 rotates around the second axis O2 as the shaft main body 12 rotates, and thus, the rack shaft moves in the vehicle width direction and the wheel is steered. Moreover, the first lower yoke 72, the lower X-shaped shaft 78, and the second lower yoke 79 constitute a lower universal joint 85.

<Seal Mechanism>

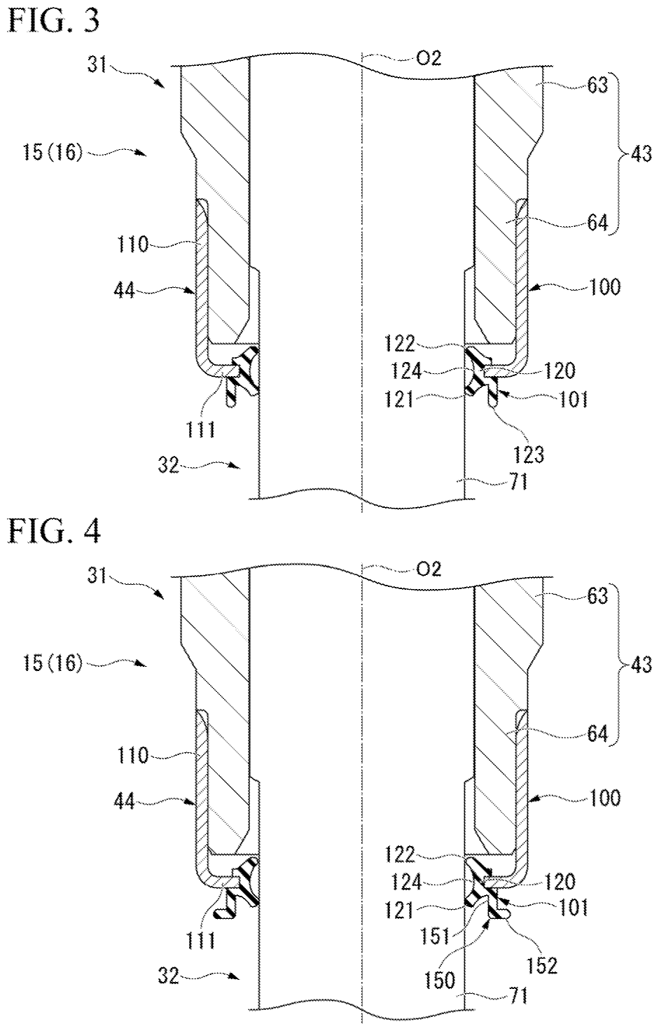

FIG. 3 is an enlarged cross-sectional view of the intermediate shaft 15.

As shown in FIG. 3, the seal mechanism 44 includes a seal holder 100 and a seal member 101.

The seal holder 100 includes a holding pipe 110 and an attachment flange 111.

The small-diameter portion 64 of the upper shaft 31 is fitted into the holding pipe 110.

The attachment flange 111 protrudes toward an inside in the second radial direction from a lower end edge of the holding pipe 110. The attachment flange 111 is close to an outer peripheral surface of the lower shaft 32.

The seal member 101 is interposed between the attachment flange 111 and the lower shaft 32. The seal member 101 seals between the attachment flange 111 and the lower shaft 32. The seal member 101 includes a root portion 120, a first lip portion (lip portion) 121, a second lip portion (lip portion) 122, and a flange portion 123.

The root portion 120 is attached to the entire periphery of an inner end edge of the attachment flange 111 in the second radial direction.

The first lip portion 121 protrudes from the root portion 120 to the inside in the second radial direction. A distal end portion of the first lip portion 121 comes into close contact with the outer peripheral surface of the lower shaft 32. In the present embodiment, the first lip portion 121 is inclined downward as the first lip portion 121 goes toward the inside in the second radial direction. Accordingly, the first lip portion 121 is configured to be flexibly deformable in the second radial direction.

The second lip portion 122 protrudes from the root portion 120 to the inside in the second radial direction. A distal end portion of the second lip portion 122 comes into close contact with the outer peripheral surface of the lower shaft 32. In the present embodiment, the second lip portion 122 is inclined upward as the second lip portion 122 goes toward the inside in the second radial direction. Accordingly, the second lip portion 122 is configured to be flexibly deformable in the second radial direction.

A portion of the seal member 101 surrounded by the first lip portion 121 and the second lip portion 122 constitutes a lubricant storage portion (first lubricant storage portion) 124 in which lubricant is stored. The lubricant stored in the lubricant storage portion 124 is supplied to a portion between the lip portions 121 and 122 and the outer peripheral surface of the lower shaft 32, or the like.

The flange portion 123 protrudes downward from a portion of the root portion 120 located outside the first lip portion 121 in the second radial direction. The flange portion 123 surrounds the entire periphery around the first lip portion 121 and is formed in a tubular shape which is disposed coaxially with the second axis O2. However, a portion of the flange portion 123 in the second circumferential direction may be cut out or the like.

The flange portion 123 is formed to have a uniform diameter over the entire length in the second axis direction. However, the flange portion 123 may be configured to decrease or increase in diameter as the flange portion 123 goes downward.

A front end portion (lower end portion) of the flange portion 123 protrudes forward (downward) from the first lip portion 121. The flange portion 123 may be formed integrally with the seal holder 100.

The intermediate shaft 15 of the present embodiment is disposed at a position exposed to an external environment outside the vehicle compartment. Accordingly, there is a possibility that water or the like may enter a fitting portion of the intermediate shaft 15 at the time of running-up or when submerged.

For example, water adhering to the outer peripheral surface or the like of the upper shaft 31 moves downward along an outer peripheral surface of the upper shaft 31. For example, thereafter, the water or the like moving downward on the outer peripheral surface of the tubular portion 43 reaches the seal member 101 along an outer peripheral surface of the seal holder 100. The water or the like which has reached the seal member 101 moves downward on an outer peripheral surface of the flange portion 123, and thereafter, drops from a front end portion of the flange portion 123. That is, the water or the like drops without going around the first lip portion 121.

The water or the like scattered from a side of the intermediate shaft 15 toward the seal member 101 adheres to the flange portion 123, and thus, drops without going around the first lip portion 121. The flange portion 123 can prevent a liquid scattered from a lower side of the intermediate shaft 15 toward the seal member 101 from directly entering the first lip portion 121.

Even if the water or the like scattered toward the intermediate shaft 15 reaches the first lip portion 121, the first lip portion 121 blocks the water, and thus, entry of the water between the lower shaft 32 and the upper shaft 31 is restricted.

As described above, in the present embodiment, the flange portion 123 which surrounds a periphery of the first lip portion 121 and protrudes downward from the first lip portion 121 is provided.

According to this configuration, the first lip portion 121 is covered by the flange portion 123, and thus, the water or the like reaching the first lip portion 121 can be reduced. Thereby, entry of water or the like into the fitting portion of the lower shaft 32 and the upper shaft 31 can be suppressed.

The water or the like reaching the first lip portion 121 is reduced, and thus, a water pressure acting on the first lip portion 121 can be reduced. Therefore, a seal load (a load acting on an outer peripheral surface of the lower shaft 32 from the first lip portion 121) is reduced, and thus, sealing performance can be secured. The seal load is reduced, and thus, a sliding resistance between the first lip portion 121 and the lower shaft 32 is reduced, and durability can be improved. Accordingly, axial movements of the upper shaft 31 and the lower shaft 32 is smoothly performed over a long period of time.

In the present embodiment, the first lip portion 121 is configured to extend downward as the first lip portion 121 goes toward the inside in the second radial direction.

According to this configuration, the water or the like which has reached the first lip portion 121 from below can be more reliably blocked at the first lip portion 121. The first lip portion 121 is easily bent and deformed in the second radial direction, and thus, the seal load can be reduced.

In the present embodiment, the second lip portion 122 is provided behind the first lip portion 121.

According to this configuration, since a plurality of the lip portions 121 and 122 are arranged in the up-down direction, the sealing performance can be further improved.

A portion between the lip portions 121 and 122 is the lubricant storage portion 124, and thus, lubricant is easily supplied between the lip portions 121 and 122 and the lower shaft 32. Therefore, a sliding resistance between the lip portions 121 and 122 and the lower shaft 32 can be reduced. Lubricant is supplied between the lip portions 121 and 122 and the lower shaft 32, and thus, a gap between the lip portions 121 and 122 and the lower shaft 32 can be filled with lubricant. Thereby, the sealing performance can be further improved.

In the present embodiment, the flange portion 123 extends coaxially with the second axis O2 (to be parallel to the second axis direction).

For example, according to this configuration, compared to a configuration in which a diameter of the flange portion 123 increases toward the lower side, the water or the like can be prevented from reaching the first lip portion 121 through a portion between the outer surface of the shaft 71 and the flange portion 123. Meanwhile, for example, compared to a configuration in which the diameter of the flange portion 123 decreases toward the lower side, the water or the like moving downward on the outer peripheral surface of the flange portion 123 can be prevented from adhering to the outer peripheral surface of the shaft 71.

The steering device 1 of the present embodiment includes the above-described intermediate shaft 15, and thus, the steering device 1 having improved durability can be provided.

### MODIFICATION EXAMPLE

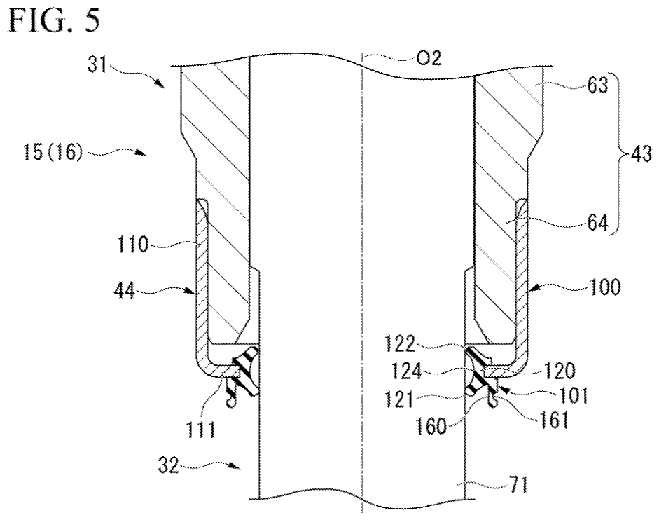

FIGS. 4 and 5 are cross-sectional views corresponding to FIG. 3 according to modification examples.

In the above-described embodiment, the configuration in which the flange portion 123 is formed in a straight line is described. However, the present invention is not limited to this configuration. For example, as shown in FIG. 4, the flange portion 150 may be configured to include a peripheral wall portion 151 and a return portion 152 which protrudes from a lower end portion of the peripheral wall portion 151 to the outside in the second radial direction. Thereby, water which has flowed along an outer peripheral surface of the peripheral wall portion 151 flows to the outside in the second radial direction by the return portion 152, and thus, the water can be separated from the lip portion 121.

As in a flange portion 160 shown in FIG. 5, a groove portion 161 may be formed on an outer peripheral surface of the flange portion 160. Accordingly, the water flowing through the outer peripheral surface of the flange portion 160 can be blocked by the groove portion 161.

### Second Embodiment

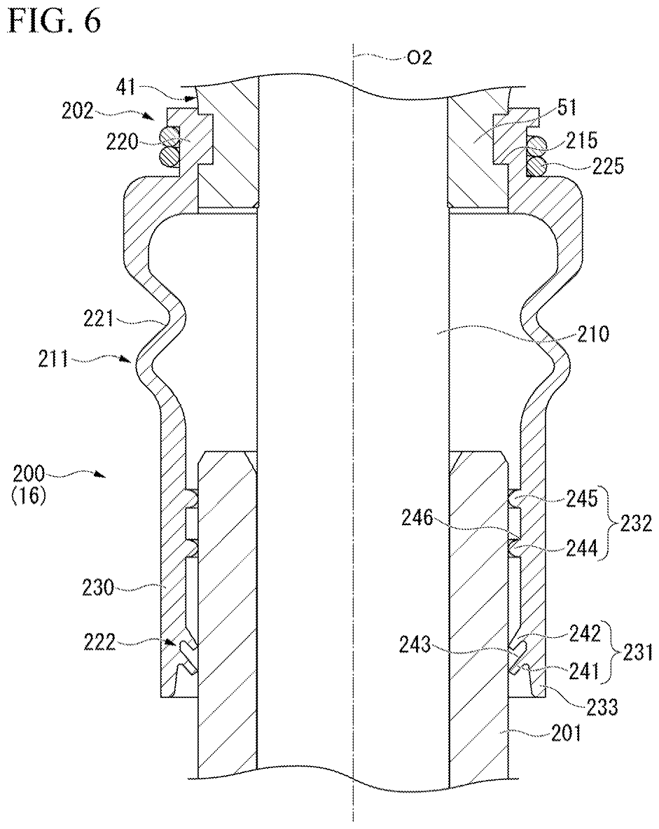

Next, a second embodiment according to the present invention will be described. FIG. 6 is a cross-sectional view of the intermediate shaft 200 according to the second embodiment. The present embodiment is different from the above-described first embodiment in that a solid upper shaft 202 is inserted into a tubular lower shaft 201 so as to be relatively movable. In the following descriptions, the same reference numerals may be assigned to the same configurations as those of the first embodiment, and descriptions thereof may be omitted.

In the intermediate shaft 200 shown in FIG. 6, the lower shaft 201 is formed in a tubular shape disposed coaxially with the second axis O2. A female spline is formed on an inner peripheral surface of the lower shaft 201. An outer peripheral surface of the lower shaft 201 is formed as a smooth surface.

The upper shaft 202 includes a shaft 210, the first upper yoke 41, and a cover member 211.

The shaft 210 is a solid shaft disposed coaxially with the second axis O2. A male spline is formed on the outer peripheral surface of the shaft 210. The shaft 210 is inserted into the lower shaft 201 in a state where the shaft 210 engages (meshes) with the female spline of the lower shaft 201. The shaft 210 is configured to be movable in the up-down direction (second axis direction) with respect to the lower shaft 201 in a state where a rotation of the shaft 210 in the second circumferential direction is restricted. An upper end portion of the shaft 210 is fitted into the first upper base 51 of the first upper yoke 41. A circumferential groove 215 which opens to the outside in the second radial direction is formed on an outer peripheral surface of the first upper base 51.

The cover member 211 is formed in a tubular shape which surrounds a periphery of the shaft 210 in a state where the cover member 211 straddles between the first upper base 51 and the lower shaft 201. The cover member 211 includes an attachment 220, a displacement absorber 221, and a seal mechanism 222.

The attachment 220 is formed in a tubular shape disposed coaxially with the second axis O2. The attachment 220 is held around the first upper base 51 in a state where a portion of the attachment 220 is fitted to the circumferential groove 215 of the first upper base 51. The attachment 220 is fastened from the outside in the second radial direction by a fastening ring 225.

The displacement absorber 221 is continuous downward from a lower end edge of the attachment 220. The displacement absorber 221 is configured to have a diameter larger than that of the attachment 220 and to be expandable and shrinkable in the up-down direction. The displacement absorber 221 is formed in a bellows shape extending downward while meandering in the second radial direction in a cross-sectional view. The displacement absorber 221 may be more easily elastically deformed than a portion of the cover member 211 other than the displacement absorber 221. For example, the displacement absorber 221 may be formed thinner than portions other than the displacement absorber 221, or the like.

The seal mechanism 222 includes a cylindrical portion 230, a first seal 231, a second seal (double seal) 232, and a flange portion 233.

The cylindrical portion 230 is continuous downward from a lower end edge of the displacement absorber 221. The cylindrical portion 230 surrounds the entire periphery around a rear end portion of the lower shaft 201.

The first seal 231 is formed in a lower end portion of the cylindrical portion 230. The first seal 231 has a double seal structure. That is, the first seal 231 includes a lower lip portion 241 and an upper lip portion 242 which are arranged in the up-down direction.

Each of the lip portions 241 and 242 is inclined downward as it goes toward the inside in the second radial direction. An inclination angle of each of the lip portions 241 and 242 can be appropriately changed.

In the seal mechanism 222, a portion thereof surrounded by the lower lip portion 241 and the upper lip portion 242 constitutes a first lubricant storage portion 243 in which lubricant is stored.

The second seal 232 is formed in an upper end portion of the cylindrical portion 230. The second seal 232 has a double seal structure. That is, the second seal 232 includes a lower lip portion 244 and an upper lip portion 245 which are arranged in the up-down direction.

Each of the lip portions 244 and 245 is formed in a semicircular shape which is convex toward the inside in the second radial direction in a cross-sectional view. In addition, a shape of each of the lip portions 244 and 245 in a cross-sectional view can be appropriately changed.

In the seal mechanism 222, a portion thereof surrounded by the lower lip portion 244 and the upper lip portion 245 constitutes a second lubricant storage portion 246 in which lubricant is stored.

The flange portion 233 protrudes downward from the cylindrical portion 230. A lower end portion of the flange portion 233 protrudes downward from the lower lip portion 241. The flange portion 233 is formed in a tubular shape which surrounds the entire periphery around the lower lip portion 241 and is disposed coaxially with the second axis O2.

In the present embodiment, in addition to the same operations and effects as those of the above-described first embodiment, the following operations and effects are achieved.

For example, in the present embodiment, the seal mechanism 222 includes a second seal 232 above the first seal 231. Therefore, lubricant can be stored in the second lubricant storage portion 246 defined by the second seal 232. Accordingly, lubricant is easily supplied between the lip portions 244 and 245 and the lower shaft 32. Therefore, a sliding resistance between the lip portions 244 and 245 and the lower shaft 32 can be reduced.

Moreover, each of the lip portions 244 and 245 of the second seal 232 is formed in a semicircular shape. Therefore, the lip portions 244 and 245 are prevented from being caught on the outer peripheral surface of the lower shaft 201 with respect to a movement of the lower shaft 201 toward both the upper and lower sides, and thus, the lower shaft 201 can be smoothly moved.

In the present embodiment, the cover member 211 includes the displacement absorber 221. Accordingly, relative movements of the lower shaft 201 and the upper shaft 202 can be absorbed by deformation of the displacement absorber 221. Therefore, relative movement between the lower shaft 201 and the seals 231 and 232 can be suppressed, and wear or the like of the seals 231 and 232 can be suppressed.

### Other Modification Examples

Hereinbefore, the preferred embodiments of the present invention are described. However, the present invention is not limited to the embodiments. Additions, omissions, substitutions, and other modifications of configurations can be made within a scope which does not depart from the spirit of the present invention. The present invention is not limited by the above descriptions, but only by the appended claims.

For example, in the above-described embodiment, the configuration in which the universal joints are provided at both upper and lower end portions of the intermediate shaft is described. However, the present invention is not limited to this configuration.

In the above-described embodiments, the case where each seal has the double seal structure is described. However, the present invention is not limited to this configuration. That is, each seal may be formed of one lip portion.

In the above-described embodiments, the configuration in which the cross section of each of the lower shaft and the upper shaft is circular is described. However, the present invention is not limited to this configuration. Each of the lower shaft and the upper shaft may have a polygonal shape or the like in a cross-sectional view.

In the above-described embodiments, the intermediate shaft having the two-stage configuration of the lower shaft and the upper shaft is described as the steering shaft according to the present invention. However, the present invention is not limited to this configuration, and a three-stage configuration may be used. Also, in this case, it is preferable to provide the seal mechanism in the upper shaft among the shafts adjacent in the front-rear direction.

In the above-described embodiments, the intermediate shaft which connects between the shaft main body 12 and the steering gear box is described as an example of the steering shaft according to the present invention. However, the present invention is not limited to this configuration.

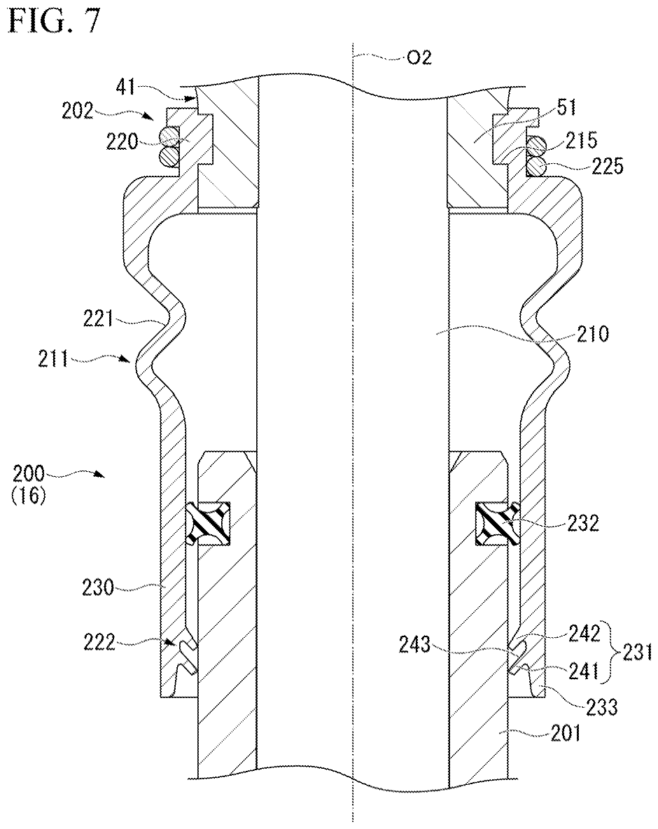

In the above-described second embodiment, the configuration in which each of the seals 231 and 232 is integrally formed with the cylindrical portion 230 is described. However, the present invention is not limited to this configuration. For example, as shown in FIG. 7, at least the second seal 232 may be separated from the cylindrical portion 230. As the second seal 232, a so-called X seal having an X shape in a cross-sectional view may be adopted.

In addition, components in the above-described embodiment can be appropriately replaced with known components within a scope which does not depart from the spirit of the present invention, and the above-described modification example may be appropriately combined with each other.

What is claimed is:

1. A steering shaft comprising:
a shaft main body configured to have a rear end portion to which a steering wheel is coupled;
an upper shaft configured to be connected to a front end portion of the shaft main body;
a lower shaft configured to be coaxially provided with the upper shaft on a lower end portion of the upper shaft, to be movable in an axial direction relative to the upper shaft, and to be rotatable integrally with the upper shaft; and
a seal mechanism configured to be provided in the upper shaft and seal between the lower shaft and the upper shaft,
wherein the seal mechanism includes
a lip portion configured to surround a periphery of the lower shaft and slide on an outer peripheral surface of the lower shaft, and
a flange portion configured to surround a periphery of the lip portion and protrude downward from the lip portion.

2. The steering shaft according to claim 1,
wherein the lip portion includes
a first lip portion configured to extend downward as the first lip portion goes toward an outer peripheral surface of the lower shaft, and
a second lip portion configured to surround the periphery of the lower shaft above the first lip portion and slide on the outer peripheral surface of the lower shaft,
wherein a first lubricant storage portion configured to store lubricant is defined between the first lip portion and the second lip portion.

3. The steering shaft according to claim 1,
wherein the seal mechanism includes a double seal configured to slide on the outer peripheral surface of the lower shaft, in a portion located above the lip portion, and
wherein a second lubricant storage portion in which lubricant is stored is inside the double seal.

4. The steering shaft according to claim 3,
wherein the double seal includes a lower lip portion and an upper lip portion configured to slide on the outer peripheral surface of the lower shaft, and
wherein a shape of each of the lower lip portion and the upper lip portion in a cross-sectional view is formed in a semicircular shape which is convex toward the lower shaft.

5. The steering shaft according to claim 1,
wherein the flange portion extends along an axial direction of the upper shaft and the lower shaft.
